(19) United States
(12) Patent Application Publication
(10) Pub. No.: US 2011/0314942 A1
(43) Pub. Date: Dec. 29, 2011

(54) RANGE SWITCHING DEVICE

(75) Inventors: Takayoshi YONEZU, Nishio-shi (JP); Keiji SUZUKI, Anjo-shi (JP); Takahito ODA, Chiryu-shi (JP)

(73) Assignee: AISIN AW CO., LTD., Anjo-shi (JP)

(21) Appl. No.: 13/116,588

(22) Filed: May 26, 2011

(30) Foreign Application Priority Data
Jun. 24, 2010 (JP) 2010-143743

(51) Int. Cl. F16H 59/12

(52) U.S. Cl. 74/473.3

(57) ABSTRACT

A range switching device controls an actuator in response to a shift command from a shift operation portion. The actuator moves a manual valve which sets a shift range of an automatic transmission based on an axial position, and has a drive shaft which, being disposed parallel to the manual valve, is driven so as to be extendable and contractible in an axial direction. The device further includes a holder portion provided at an end portion of the manual valve, and a link pin in which one end is linked to the actuator's drive shaft, and in which the other end is a spherical portion fitted into the holder portion, and engaged in point contact with two axial sides of an inner surface of the holder portion.

### INCORPORATION BY REFERENCE

The disclosure of Japanese Patent Application No. 2010-143743 filed on Jun. 24, 2010, including the specification, drawings and abstract thereof, is incorporated herein by reference in its entirety.

### BACKGROUND OF THE INVENTION

1. Field of the Invention

The present invention relates to a range switching device which switches the shift range of an automatic transmission such as a multispeed automatic transmission, a CVT, or a hybrid drive device, and particularly, relates to a shift-by-wire range switching device which moves a manual valve with an actuator which is controlled in response to a shift operation.

2. Description of the Related Art

In general, an automatic transmission has a control valve which determines a power transmission pathway by a hydraulic control, and the control valve, by moving and driving the axial position of a manual valve in accordance with a shift range selected by a shift lever, sets the output or non-output of a range pressure for each oil passage, and carries out a range switching.

The manual valve has normally been moved and driven by being mechanically linked to the shift lever, but in recent years, from a demand to improve the degree of freedom in vehicle design, or the like, a so-called shift-by-wire range switching device has been devised wherein an operation of the shift lever is converted into an electrical command, and the axial position of the manual valve is controlled by driving the actuator based on the electrical command.

Then, to date, as this kind of shift-by-wire range switching device, there has been one wherein an actuator which moves a manual valve and an actuator which drives a parking lock mechanism are configured separately, thus balancing a high speed when the range is switched and a high torque when the parking mechanism is operated, which are required of the actuator, without an increase in size or cost of the actuator (refer to JP-A-2004-16987).

### SUMMARY OF THE INVENTION

However, oil passages are intricately formed in the control valve, and great effort and cost is necessary to change the design thereof. For this reason, it has been desired to make a control valve, even though the control valve is of an automatic transmission mounted with a shift-by-wire range switching device, common to that of an automatic transmission on which is mounted a heretofore known range switching device, wherein a shift lever and a manual valve are mechanically linked.

However, for example, when attempting to mount the shift-by-wire range switching device described in Patent Document 1 on the control valve on which is mounted the mechanically linked range switching device, as the actuator has the thickness of a body, it is difficult to coaxially dispose the drive shaft of the actuator and the manual valve without changing the design of the control valve.

Therefore, there has been an attempt to move and drive the manual valve by linking the drive shaft of the actuator and the manual valve, the axial positions of which are offset from one another, but simply by linking the shafts, the thrust of the actuator is obliquely transmitted to the manual valve in the linked portion, and there has been a problem in that the sliding resistance between the manual valve and valve body increases due to the manual valve being moved and driven askew.

Therefore, the invention has an object of providing a range switching device wherein a spherical surface is formed on a manual valve side of a link pin which links an actuator and a manual valve, and the spherical surface and a holder provided at an end portion of the manual valve are engaged in point contact, thereby solving the heretofore described problem.

The invention is, for example, as shown in FIGS. 3 and 5, a range switching device (1) which, including an actuator (20) which moves a manual valve (10) which sets a shift range of an automatic transmission based on an axial position, controls the actuator (20) in response to a shift command from a shift operation portion (5), wherein

the actuator (20) has a drive shaft (21) which, being disposed parallel to the manual valve (10), is driven so as to be extendable and contractible in an axial direction, the device characterized by including:

a holder portion (33, 43) provided at an end portion of the manual valve (10); and

a link pin (31, 41) of which one end side (31b, 41b) is linked to the drive shaft (21) of the actuator (20), and which has on the other end side a spherical portion (31a, 41a₁) which, as well as being fitted into the holder portion (33, 43), is engaged in point contact with two axial sides of an inner surface (33a₁, 43b₁) of the holder portion (33, 43).

Specifically, as shown in FIGS. 1 to 3, the link pin (31) may have a projecting portion (31c) which, being protruded in a radial direction between the one end side (31b) and spherical portion (31a), abuts against an outer surface (33c) of the holder portion (33), and regulates the point contact position of the spherical portion (31a).

Specifically, as shown in FIGS. 5 to 7, a configuration may be such that the link pin (41) has on the other end side the spherical portion (410 and a chamfered planar portion (41a₂),

a cylindrical first hole (43b) and a second hole (43a) of approximately the same form as that of the outer peripheral surface of the link pin (41) are formed in the holder portion (43) in such a way as to be perpendicular to each other, and

as well as the link pin (41) being fitted into the holder portion (43) from the second hole (43a), the spherical portion (41a₁) is allowed to rotate at an intersection of the first hole (43b) and second hole (43a), and is opposed to, and makes point contact with, the inner peripheral surface of the first hole (43b).

Also, it is preferable that the link pin (31, 41) is subjected to a quenching treatment.

Furthermore, it is preferable that the device includes an actuator side holder (32) for linking the link pin (31, 41) to the drive shaft (21) of the actuator (20), wherein

the one end side of the link pin (31, 41) is force-fitted into the actuator side holder (32), and linked to the drive shaft (21) of the actuator (20).

Also, it is preferable that the actuator (20) is configured of a stepping motor.

The heretofore used bracketed reference numerals and characters are for the purpose of referring to the drawings, but this is an expediency in order to facilitate understanding of the invention, and does not affect the configurations of the claims in any way.

According to a first aspect of the invention, the spherical portion is formed on the other end side of the link pin engaged with the holder portion formed at the end portion of the manual valve, and the spherical portion is brought into point contact with the axial sides of the inner surface of the holder portion, whereby the link pin and actuator make contact with each other only in the point contact portions, which are approximately in the shaft center position of the manual shaft, even in the event that the link pin is inclined by a thrust from the actuator, and it is possible to transmit only an axial component force to the manual valve. For this reason, even in the event that the drive shaft of the actuator and the manual valve are mounted in a condition in which their shaft center positions are offset from one another, it is possible to move and drive the manual valve with a small amount of sliding resistance, and it is possible to use the same control valve in both a shift-by-wire range switching device and a heretofore known mechanically linked shift switching device.

According to a second aspect of the invention, the projecting portion protruded in the radial direction is provided between the one end side and the spherical portion, and the projecting portion is brought into abutment with the outer surface of the valve side holder when mounting the link pin, whereby it is possible to regulate the position of the spherical portion, and bring the spherical portion into exact point contact with the inner surface of the valve side holder in the shaft center position of the manual valve.

According to a third aspect of the invention, the cylindrical first hole and the second hole formed in approximately the same form as that of the outer peripheral surface of the link pin are bored in the holder portion formed at the end portion of the manual valve in such a way as to be perpendicular to each other, and a configuration is such that, as well as the link pin being fitted into the holder portion from the second hole, the spherical portion rotates at the intersection of the first hole and second hole, and makes point contact with the inner peripheral surface of the holder portion, whereby it is possible to reliably bring the spherical portion of the link pin into point contact with the holder portion in the vicinity of the shaft center of the manual valve.

According to a fourth aspect of the invention, the link pin is subjected to a quenching treatment, thus improving the surface hardness of the pin, whereby it is possible to reduce the abrasion of the spherical portion making point contact.

According to a fifth aspect of the invention, the link pin is force-fitted into the actuator side holder, and mounted integrally in the actuator side holder, whereby it is possible to eliminate a rattling of the link pin caused by a clearance between the actuator side holder and the link pin, and it is possible to compactly form the actuator side holder.

According to a sixth aspect of the invention, a stepping motor is employed as the actuator, whereby it is possible to control the axial position of the manual valve with a higher accuracy in comparison with a motor such as, for example, a brushless motor which carries out no step-by-step drive.

### BRIEF DESCRIPTION OF THE DRAWINGS

FIG. 1A is a schematic diagram showing a mounting condition of a range switching device according to a first embodiment of the invention, and FIG. 1B is a plan view of FIG. 1A;

FIG. 2A is a plan view showing a link mechanism of the range switching device according to the first embodiment of the invention, FIG. 2B is a side view showing the link mechanism of the range switching device according to the first embodiment of the invention, and FIG. 2C is an assembly diagram showing the link mechanism of the range switching device according to the first embodiment of the invention;

FIG. 3A is a perspective view of FIG. 2A, FIG. 3B is an A₁-A₁ sectional view of FIG. 2A, and FIG. 3C is a B₁-B₁ sectional view of FIG. 2A;

FIG. 4A is a plan view showing a link mechanism of a range switching device according to a second embodiment of the invention, FIG. 4B is a side view showing the link mechanism of the range switching device according to the second embodiment of the invention, and FIG. 4C is a bottom view showing the link mechanism of the range switching device according to the second embodiment of the invention;

FIG. 5A is a perspective view of FIG. 4A, FIG. 5B is an A₂-A₂ sectional view of FIG. 4A, and FIG. 5C is a B₂-B₂ sectional view of FIG. 4A;

FIG. 6A is a perspective view showing a manual valve according to the second embodiment of the invention, FIG. 6Bi is a plan view showing the manual valve according to the second embodiment of the invention, FIG. 6C is a side view showing the manual valve according to the second embodiment of the invention, and FIG. 6D is a bottom view showing the manual valve according to the second embodiment of the invention; and

FIG. 7 is a process chart showing a mounting process of a link pin of the range switching device according to the second embodiment of the invention.

### DETAILED DESCRIPTION OF THE INVENTION

Hereafter, a description will be given, based on the drawings, of a range switching device according to embodiments of the invention.

### First Embodiment

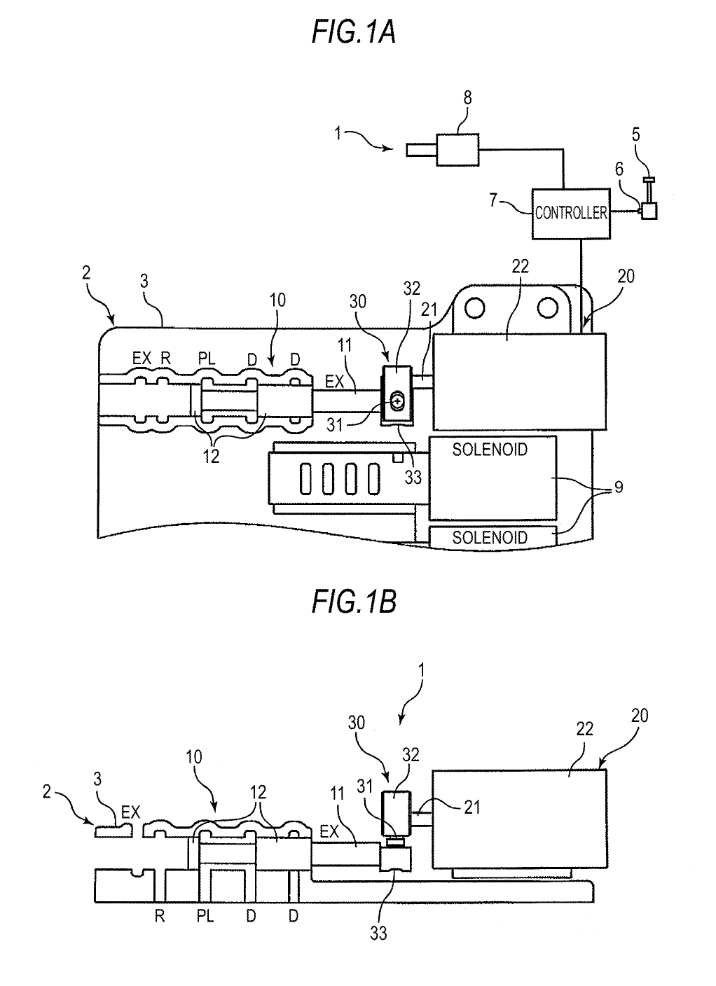

As shown in FIG. 1, a control valve 2 which hydraulically controls the engagement and disengagement of clutches and brakes which determine the transmission pathway of an automatic transmission has a vertically mounted valve body 3. As well as a plurality of linear solenoid valves 9 for adjusting the engagement pressures of the clutches and brakes being fitted in the valve body 3 in such a way as to be approximately parallel to the width direction of the valve body 3, a manual valve 10 for setting a shift range is disposed in an end portion of the valve body 3 and on the upper side of the linear solenoid valves 9.

The manual valve 10, being configured of a shaft portion 11 and a spool 12 fitted into the valve body 3, switches the axial position of the manual valve 10 in accordance with a shift range selected by a shift lever (a shift operation portion) 5 provided in the vicinity of a driver's seat, thereby setting an output condition or non-output condition (drain) of a line pressure which is the original pressure of the linear solenoid valves 9, or the like, for each oil passage.

The axial position of the manual valve 10 is moved and driven by a stepping motor 20 acting as a rectilinear actuator, and the stepping motor 20 has a drive shaft 21 which is driven so as to be extendable and contractible in the axial direction, and a motor body 22 which supports the drive shaft 21. Also, the stepping motor 20 is fixed to an upper side surface of the valve body 3 by a bolt and, as the motor body 22 is thick, the drive shaft 21 is disposed parallel to the manual valve 10. That is, the drive shaft 21, as well as being disposed offset in a radial direction from the shaft portion 11 of the manual valve 10, extends parallel thereto in the axial direction.

The manual valve 10 shaft portion 11 and the stepping motor 20 drive shaft 21, the radial positions of which are offset from one another, are linked by a link mechanism 30, and the thrust of the stepping motor 20 is transmitted to the manual valve 10 via the link mechanism 30.

Also, the stepping motor 20 is connected to a controller 7. The controller 7 controls the stepping motor 20 based on a shift command which is an electrical signal from a detection sensor 6 which detects the position of the shift lever 5, and moves the manual valve 10 in accordance with the shift position. Furthermore, the controller 7 is also connected to a parking motor 8 which controls a parking lock mechanism (not shown) and, when the shift command is for a parking position, controls the parking motor 8 in such a way that the parking lock mechanism is in a locked condition. Then, the stepping motor 20, controller 7, link mechanism 30, and the like, configure a range switching device 1 which switches the shift range of the automatic transmission.

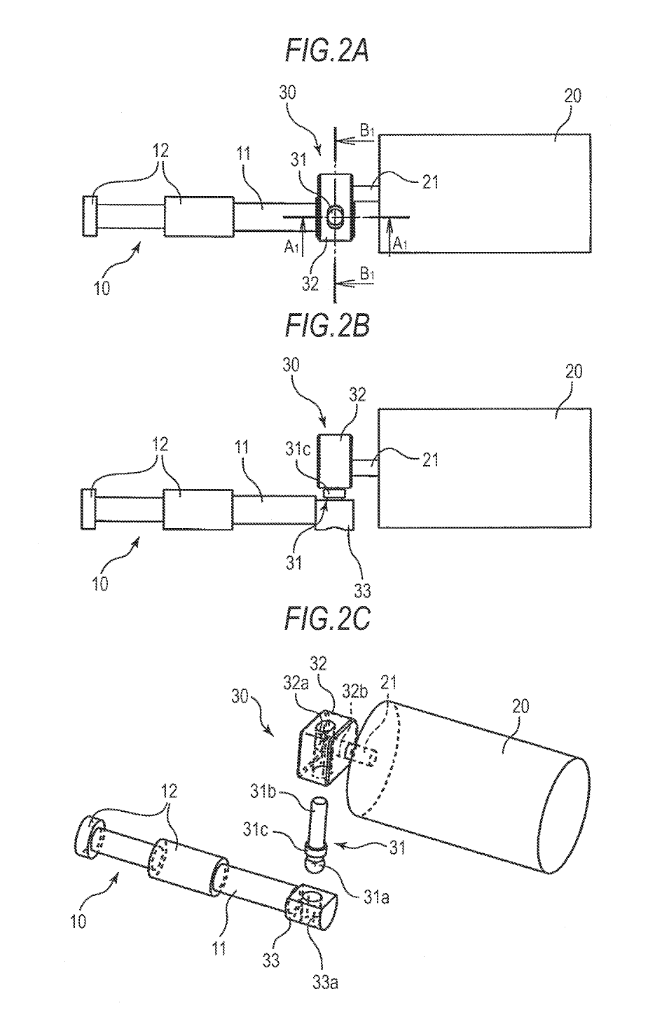

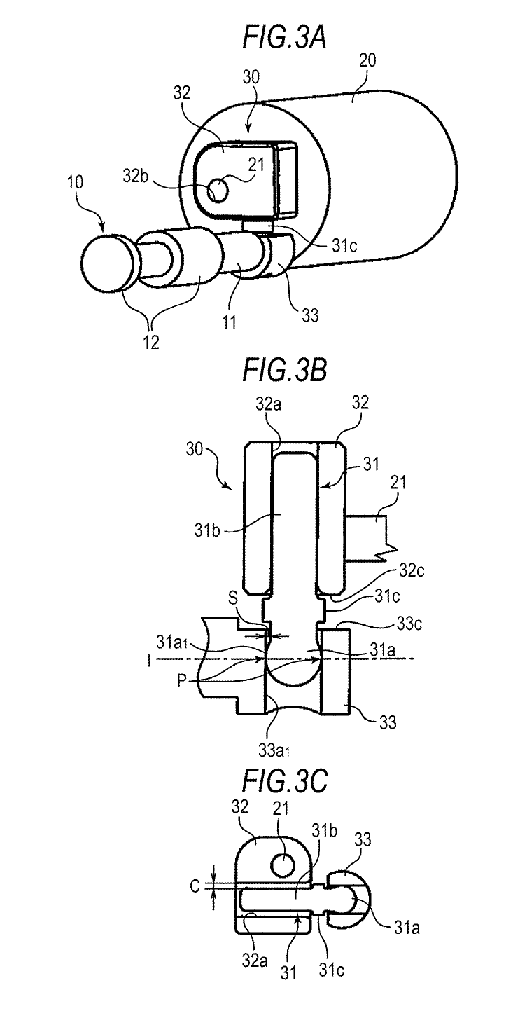

Next, a detailed description will be given of the link mechanism 30. As shown in FIGS. 2 and 3, the link mechanism 30 has a motor side holder (an actuator side holder) 32 attached to the drive shaft 21 of the stepping motor 20, a valve side holder (a holder portion) 33 provided at an end portion of the manual valve 10, and a link pin 31 which links the motor side holder 32 and valve side holder 33. The motor side holder 32 is an approximately rectangular parallelepiped shaped holder for linking the link pin 31 to the drive shaft 21 of the stepping motor 20, and a cylindrical motor shaft mounting hole 32b, into which the drive shaft 21 of the stepping motor 20 is fitted, and a one end side pin mounting hole 32a, into which one end side of the link pin 31 is fitted, are bored in directions in which they are perpendicular to each other and with the widthwise positions of the holders offset from one another so as not to overlap each other.

Also, the one end side pin mounting hole 32a being formed in an elliptical shape, as well as there being little clearance between one end side 31b of the link pin 31 and the one end side pin mounting hole 32a of the motor side holder 32 in the axial direction of the manual valve 10 in which the thrust of the stepping motor 20 is generated, as shown in FIG. 3B, there is a predetermined clearance c therebetween in the width direction of the holder 32, as shown in FIG. 3C, and a configuration is such that it is possible to adjust the position of the motor with respect to the link pin 31. Then, the motor side holder 32 is such that the length in the height direction thereof (in the axial direction of the link pin) is formed to be long enough for the link pin 31 not to rattle due to the clearance between the motor side holder 32 and the link pin 31.

Meanwhile, the link pin 31 is such that, as well as the one end side 31b fitted into the one end side pin mounting hole 32a of the motor side holder 32 being made a rod-like pin, a spherical power transmission portion 31a which transmits power to the manual valve 10 is formed on the other end side engaged with the valve side holder 33. As shown in FIG. 3A and FIG. 3B, the power transmission portion 31a is fitted into an other end side pin mounting hole 33a bored in the valve side holder 33 in such a way that the other end side pin mounting hole 33a is opposed to the one end side pin mounting hole 32a, and a spherical surface (a spherical portion) 31a₁ of the power transmission portion 31a is engaged in point contact with an inner peripheral surface (an inner surface) 33a₁ of the cylindrical other end side pin mounting hole 33a in a shaft center position 1 (point contact portions P) of the manual valve 10. That is, the spherical surface 31a₁ is formed in such a way as to make point contact with at least two axial sides of the inner peripheral surface 33a₁ of the valve side holder 33, and transmit the axial thrust of the actuator 20 to the manual valve 10 via the point contact portions P.

Also, the link mechanism 30 is assembled by firstly fitting the power transmission portion 31a of the link pin 31 into the manual valve 10 valve side holder 33 whose axial position has been adjusted with respect to the oil passage, and subsequently, fitting the one end side 31b of the link pin 31 into the motor side holder 32 mounted on the stepping motor 20, but an annular stopper (projecting portion) 31c is formed between the one end side and other end side of the link pin 31 in such a way that the spherical surface 31a₁ of the power transmission portion 31a makes point contact with the inner peripheral surface (inner surface) 33a₁ of the other end side pin mounting hole 33a in the shaft center position 1 of the manual valve 10 when the link mechanism 30 is assembled.

Specifically, the stopper 31c, being a large diameter portion protruded in the radial direction of the link pin 31 between the one end portion 31b and spherical surface 31a₁, is formed in such a way as to regulate the point contact position of the spherical surface 31a₁ by being positioned between the motor side holder 32 and valve side holder 33 in the condition in which the link mechanism 30 is assembled, as well as by abutting against an outer surface (a top surface) 33c of the valve side holder 33 into which the other end side pin mounting hole 33a opens.

Furthermore, the link pin 31 being subjected to a quenching treatment such as a case hardening or a high frequency hardening, the surface hardness thereof is increased, reducing the abrasion or the like of the power transmission portion 31a making point contact.

Next, a description will be given of an action of the embodiment. When a driver operates the shift lever 5 and changes the shift range, the operation is converted into an electrical signal (a shift command) by the detection sensor 6, and input into the controller 7. The controller 7, when the shift command from the shift lever 5 is input thereinto, controls the stepping motor 20 and causes the drive shaft 21 to extend or contract in such a way that the spool 12 of the manual valve 10 is positioned in an axial position corresponding to the shift range.

When the drive shaft 21 of the stepping motor 20 extends or contracts, the thrust thereof is transmitted to the link pin 31 via the motor side holder 32 but, at this time, moment occurs in the link pin 31 with the point contact portions P of the link pin 31 and valve side holder 33 as a fulcrum. Then, it may happen that the link pin 31 inclines slightly in the axial direction of the manual valve 10 due to the moment but, even in the event that the link pin 31 inclines, the contact position of the spherical surface 31a₁ of the power transmission portion 31a only changes, and the power transmission portion 31a of the link pin 31 always makes contact with the inner peripheral surface 33a₁ of the other end side pin mounting hole 33a (valve side holder 33) in the shaft center position 1 of the manual valve 10. Also, a predetermined gap s is provided between a portion of the link pin 31 other than the power transmission portion 31a and the inner peripheral surface 33a₁ of the other end side pin mounting hole 33a, and the link pin 31 does not make contact with any portion of the valve side holder 33 other than the point contact position P of the other end side pin mounting hole 33a, meaning that only the axial component thrust of the stepping motor 20 is transmitted to the manual valve 10, and the manual valve 10 is moved and driven in the axial direction by a small amount of sliding resistance without inclining and without the spool 12 being pressed against the valve body 3.

In this way, a configuration is adopted wherein the contact point of the link pin 31 and manual valve 10 is always in the shaft center of the manual valve 10 by providing the spherical power transmission portion 31a on the link pin 31 which can be inclined by the thrust from the stepping motor 20, and bringing the spherical surface 31a₁ of the power transmission portion 31a into point contact with the inner peripheral surface 33a₁ of the valve side holder 33. Consequently, even when the drive shaft 21 of the stepping motor 20 is disposed offset from the manual valve 10, it is possible to transmit only the axial component thrust to the manual valve 10.

Then, because of this, the manual valve 10 can be moved and driven by a small amount of sliding resistance without being inclined even when the drive shaft 21 of the stepping motor 20 is not disposed coaxially with the shaft center 1 of the manual valve 10, meaning that the shift-by-wire range switching device 1 can be mounted, without changing the control valve 2 side design, on the control valve 2 on which a mechanically linked range switching device is mounted.

Also, by using the stepping motor 20 as an actuator which moves the manual valve 10, it is possible to control the axial position of the manual valve 10 with a higher accuracy in comparison with a motor such as a brushless motor which carries out no step-by-step drive.

### Second Embodiment

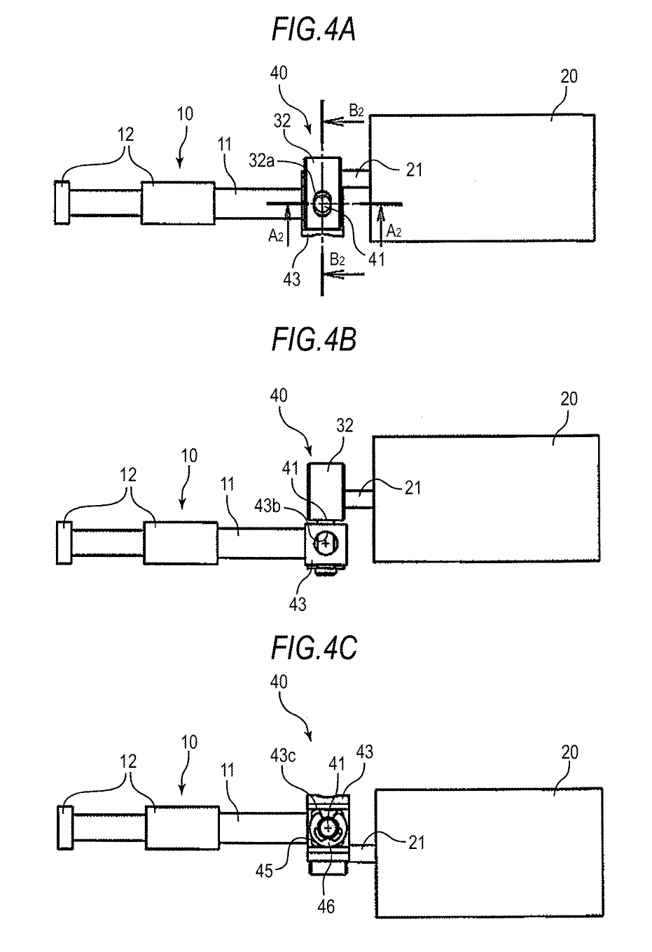

Next, a description will be given, based on FIGS. 4 to 7, of a second embodiment of the invention. The second embodiment differs from the first embodiment only in the configuration of the link mechanism and, as well as components identical to those of the first embodiment being given the same reference numerals and characters, a description thereof is omitted.

As shown in FIGS. 4 to 6, a link mechanism 40 which links the drive shaft 21 of the stepping motor 20 and the manual valve 10 is configured having the motor side holder 32, a link pin 41, and a valve side holder 43. The link pin 41 is such that a power transmission portion 41a is formed on the other end side which is fitted into the valve side holder 43, and the power transmission portion 41a has a pair of spherical portions 41a₁ formed opposed to each other and a pair of planar portions 41a₂ which, as well as being formed opposed to each other in the same way, are chamfered into a planar form.

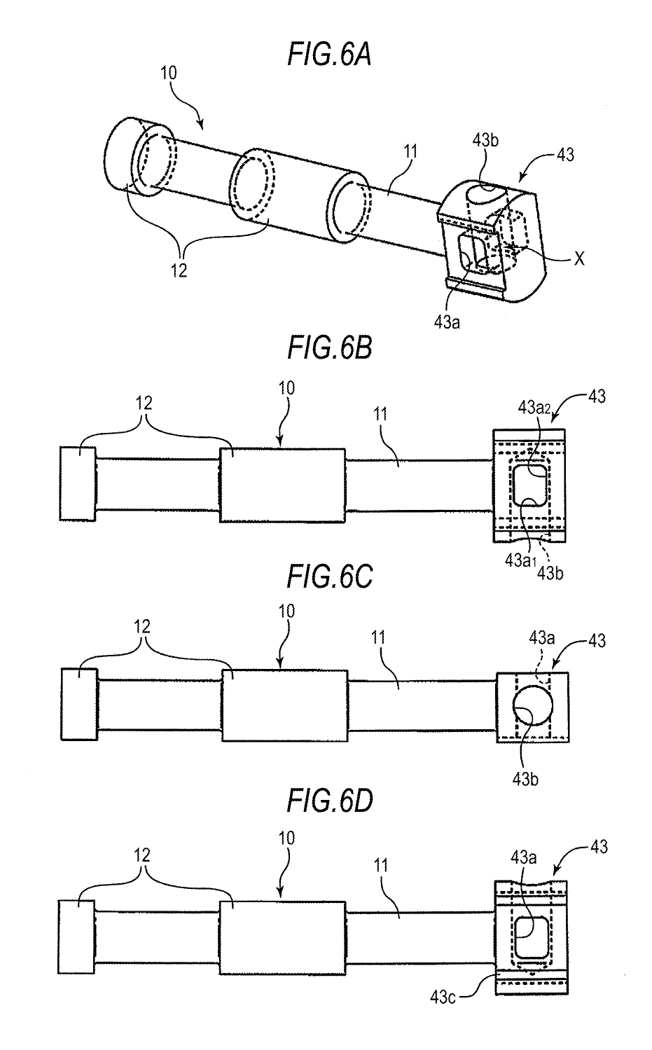

Meanwhile, a cylindrical first hole 43b and a second hole 43a into which the link pin 41 is fitted are bored in the valve side holder (holder portion) 43, formed at the end portion of the shaft portion 11 of the manual valve 10, into which the power transmission portion 41a is fitted, in such a way as to be perpendicular to each other at an intersection X. As shown in FIG. 6, the second hole 43a, being formed in approximately the same shape as that of the outer peripheral surface of the power transmission portion 41a of the link pin 41, specifically, is a rectangular hole which is formed of first surfaces 43a₁ formed to have therebetween a width through which the spherical portions 41a₁ of the power transmission portion 41a can be inserted, and second surfaces 43a₂ formed to have therebetween approximately the same width as the planar portions 41a₂ of the power transmission portion 41a.

Also, a rail portion 43c in which a C-shaped anti-rotation retainer 45 is mounted in order to prevent the link pin 41 fitted in the second hole 43a from rotating is formed in the bottom surface of the valve side holder 43, and the anti-rotation retainer 45 is configured in such a way as to be fitted into a groove 41c₁ provided on a link pin 41 leading end side 41c of the power transmission portion 41a.

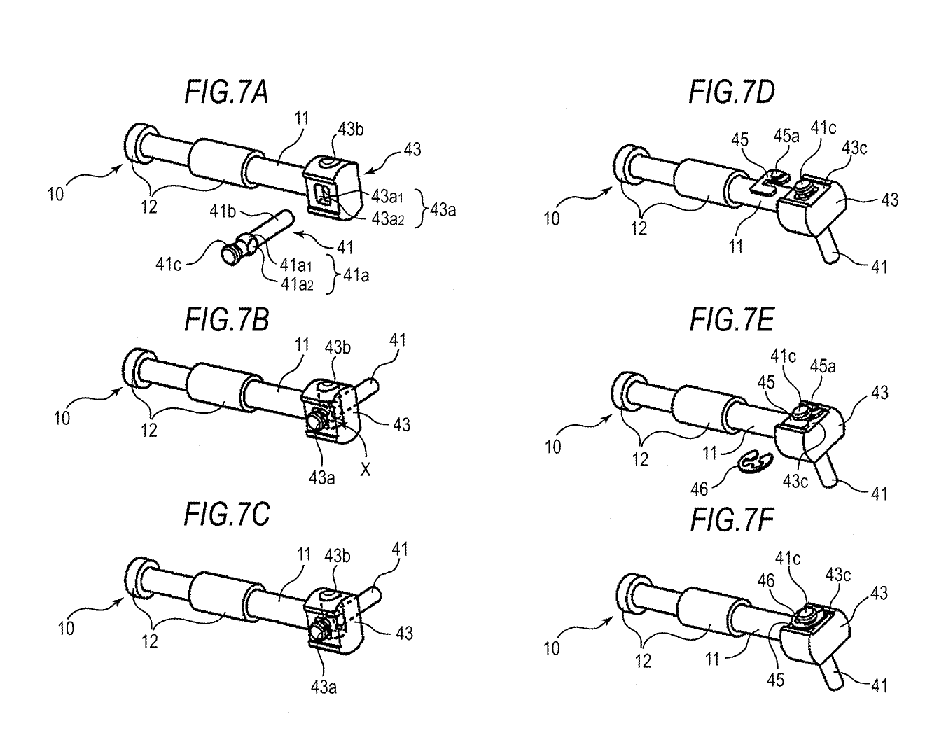

Next, a description will be given, based on FIG. 7, of a process of mounting the link pin 41 in the valve side holder 43. As shown in FIG. 7A, firstly, the link pin 41 is fitted into the second hole 43a in such a way that the planar portions 41a₂ of the power transmission portion 41a face the sides of the second surfaces 43a₂ of the second hole 43a. At this time, as the width between the second surfaces is set to a width such that the link pin 41 cannot rotate, the link pin 41 is inserted while maintaining this condition.

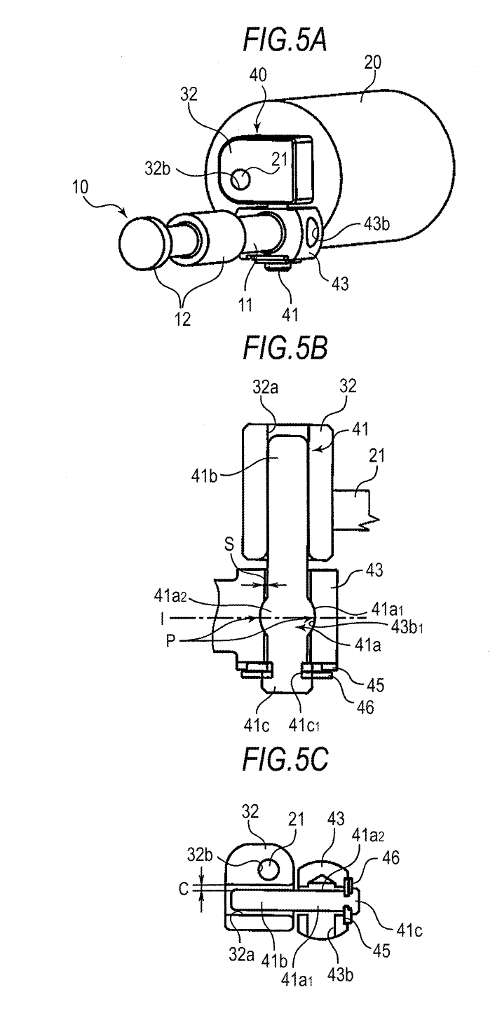

Then, when the power transmission portion 41a of the link pin 41 comes to the intersection X of the cylindrical first hole 43a and second hole 43b (refer to FIG. 7B), the width between the second surfaces becomes wider, meaning that the link pin 41 is rotated 90 degrees, and an inner peripheral surface 43b₁ of the first hole 43b bored in a direction perpendicular to the axial direction of the manual valve 10 and the spherical portions 41a₁ of the power transmission portion 41a are brought into point contact (refer to FIG. 7C and FIG. 5B). In other words, the spherical portions 41a₁ are not allowed to rotate until they come to the intersection X of the first hole 43a and second hole 43b, and the spherical portions 41a₁ and the inner peripheral surface 43b₁ of the first hole 43b are opposed to each other, and thereby make point contact.

When the spherical surfaces of the spherical portions 41a₁ of the power transmission portion 41a and the inner peripheral surface 43b₁ of the first hole 43b make point contact in the shaft center of the manual valve 10, the anti-rotation retainer 45 is mounted in the rail portion 43c, formed in the bottom surface of the valve side holder 43, in such a way as to project from the valve side holder 43 and fit into the groove 41c₁, and fixes the link pin 41 in such a way as to prevent the link pin 41 from rotating (refer to FIG. 7D). Then, an E ring 46 is attached to a projecting portion 45a formed on the anti-rotation retainer 45, the anti-rotation retainer 45 is fixed to the link pin 41, and the link pin 41 is linked to the manual valve 10.

In this way, the first hole 43b acting as a rotating hole in which the link pin 41 is allowed to rotate and the second hole 43a acting as a fitting-in hole into which the link pin 41 is fitted are formed in the valve side holder 43 so as to be perpendicular to each other and, by adopting a configuration such that two axial sides of the inner peripheral surface 43b₁ of the valve side holder 43 and the spherical portions 41a₁ of the link pin 41 make point contact by causing the power transmission portion 41a of the link pin 41 to rotate at the intersection X of the first hole 43b and second hole 43a, it is possible to reliably bring the link pin 41 into point contact with the manual valve 10 in the shaft center position 1 of the manual valve 10.

In other words, the first hole 43b and second hole 43a are bored in such a way that the intersection X thereof is formed in the shaft center position 1 of the manual valve 10.

In the first and second embodiments, one end side of the link pin 31, 41 is simply fitted in the one end side pin mounting hole 32a of the motor side holder 32, but a configuration may be such that the one end side of the link pin 31, 41 is force-fitted into the one end side pin mounting hole 32a of the motor side holder 32. As it is possible, by so doing, to prevent a rattling between the motor side holder 32 and link pin 31, 41, it is possible to compactly form the motor side holder 32. Furthermore, in the link mechanism 30 according to the first embodiment, as the position of the link pin 31 with respect to the motor side holder 32 is constant, coupled with the fact that the stopper 31c functions as a stopper when the one end side of the link pin 31, 41 is force-fitted into the one end side pin mounting hole 32a, it is possible to bring the spherical surface of the power transmission portion 31a into point contact with the inner peripheral surface 33a₁ of the manual valve 10 in the shaft center position 1 of the manual valve 10 with a higher accuracy.

Also, the stopper 31c which can abut against the motor side holder 32 outer surface (bottom surface) 32c into which the one end side pin mounting hole 32a opens, and against the outer surface 33c of the valve side holder 33, may have any form such as a simple projection, provided that the diameter of the stopper 31c is larger than the diameters of the one end side pin mounting hole 32a and other end side pin mounting hole 33a, and that the stopper 31c can abut against the outer surfaces 32c and 33c of the motor side holder 32 and valve side holder 33.

Also, the other end side pin mounting hole 33a or first hole 43b, with which the spherical surface of the power transmission portion 31a, 41a of the link pin 31, 41 makes contact, may be such that the front and back surfaces thereof in the axial direction of the manual valve 10, with which the spherical surface makes point contact when the manual valve 10 is moved and driven, are made planar, thus further reducing the contact area.

Furthermore, in the second embodiment, the link pin 41 may be such that the one end portion fitted into the motor side holder is formed in a rectangular shape, or a hole is provided in the planar portions 41a₂, and a fixing member such as a split pin is inserted therein from the first hole 43b, thus fixing the link pin 41. Also, the matters described in the first and second embodiments may naturally be combined in any way.

The range switching device according to the invention can be used for an automatic transmission such as a multispeed automatic transmission, a CVT, or a hybrid drive device, and is suitable particularly for use in a shift-by-wire range switching device which moves a manual valve with an actuator controlled in response to a shift operation.

What is claimed is:

1. A range switching device which, including an actuator which moves a manual valve which sets a shift range of an automatic transmission based on an axial position, controls the actuator in response to a shift command from a shift operation portion, wherein
the actuator has a drive shaft which, being disposed parallel to the manual valve, is driven so as to be extendable and contractible in an axial direction, the device comprising:
a holder portion provided at an end portion of the manual valve; and
a link pin of which one end side is linked to the drive shaft of the actuator, and which has on the other end side a spherical portion which, as well as being fitted into the holder portion, is engaged in point contact with two axial sides of an inner surface of the holder portion.

2. The range switching device according to claim 1, wherein
the link pin has a projecting portion which, being protruded in a radial direction between the one end side and the spherical portion, abuts against an outer surface of the holder portion, and regulates the point contact position of the spherical portion.

3. The range switching device according to claim 1, wherein
the link pin has on the other end side the spherical portion and a chamfered planar portion,
a cylindrical first hole and a second hole of approximately the same form as that of the outer peripheral surface of the link pin are formed in the holder portion in such a way as to be perpendicular to each other, and
as well as the link pin being fitted into the holder portion from the second hole, the spherical portion is allowed to rotate at an intersection of the first hole and second hole, and is opposed to, and makes point contact with, the inner peripheral surface of the first hole.

4. The range switching device according to claim 1, wherein
the link pin is subjected to a quenching treatment.

5. The range switching device according to claim 1, comprising:
an actuator side holder for linking the link pin to the drive shaft of the actuator, wherein
the one end side of the link pin is force-fitted into the actuator side holder, and linked to the drive shaft of the actuator.

6. The range switching device according to claim 2, comprising:
an actuator side holder for linking the link pin to the drive shaft of the actuator, wherein
the one end side of the link pin is force-fitted into the actuator side holder, and linked to the drive shaft of the actuator.

7. The range switching device according to claim 3, comprising:
an actuator side holder for linking the link pin to the drive shaft of the actuator, wherein
the one end side of the link pin is force-fitted into the actuator side holder, and linked to the drive shaft of the actuator.

8. The range switching device according to claim 1, wherein
the actuator is configured of a stepping motor.
